(19) United States
(12) Patent Application Publication
(10) Pub. No.: US 2008/0027363 A1
(43) Pub. Date: Jan. 31, 2008

(54) Therapeutic vibrating unit

(76) Inventors: Sarah Louisa Brueckmann, Parsonburg, MD (US); Kenneth R. Whittinghill, Ocean City, MD (US)

Correspondence Address: MAIER & MAIER, PLLC, 1000 DUKE STREET, ALEXANDRIA, VA, 22314, US

(21) Appl. No.: 11/491,956

(22) Filed: Jul. 25, 2006

(51) Int. Cl. A61H 1/00

(52) U.S. Cl. 601/70; 601/46

(57) ABSTRACT

A wearable therapeutic device is disclosed. The wearable therapeutic device may have a power source and a vibrating motor disposed in separate portions of a housing. The separate portions of the housing may be coupled and mounted on a wearable article. The power source may provide power to the vibrating motor, thus vibrating the device and providing therapy to a wearer.

### FIELD OF THE INVENTION

This invention relates to the field of wearable articles and, more particularly to therapeutic wearable articles.

### BACKGROUND

Wearable articles, such as jewelry, have existed in a variety of forms for most of recorded history. Articles such as hoops and bracelets of various forms may be easily applied to any of a variety of parts of the body and worn as jewelry. These articles are typically static and used to adorn the body.

Other wearable articles have been made that provide additional utility beyond adorning ones body. These articles often act as certain types of tools or act to conceal other types of tools. Yet other wearable articles can act to provide storage or the ability to conceal other articles. Still other articles provide alternative functions, such as illumination. These articles may have a light source and a power source, as well as some manner of activating the light source.

However, none of the above inventions or concepts, either alone or in combination, describes the present invention.

### SUMMARY

In one embodiment, a therapeutic device is disclosed. The therapeutic device may have at least one power source, at least one vibrating motor and a housing. The housing of the therapeutic device may have a first portion and a second portion that may be mated and mounted on a wearable article. The housing may also be configured to house the at least one power source and the at least one vibrating motor. Additionally, the first portion of the housing may be mated with the second portion of the housing threading mounted on both the first and second portions of the housing.

In another embodiment, a method of providing therapy is disclosed. In this embodiment, a vibrating motor may be disposed in a first portion of a housing and a battery may be disposed in a second portion of a housing. The first portion of the housing and the second portion of the housing may be coupled, and the coupled portions of the housing may be mounted on a wearable article. The wearable article may then be worn and the battery may power the vibrating motor, allowing for the vibration of the wearable article.

In another embodiment, a method of providing therapy with a wearable article is disclosed. In this embodiment, there can be a means for providing vibrations, a means for providing power, a means for housing, a means for mounting, a means for wearing the wearable article and a means for activating the means for providing vibrations.

### BRIEF DESCRIPTION OF THE DRAWINGS

Advantages of embodiments of the present invention will be apparent from the following detailed description of the preferred embodiments thereof, which description should be considered in conjunction with the accompanying drawings in which:

FIG. 1 shows an exemplary drawing of a therapeutic device.

FIG. 2 shows an exemplary drawing of a therapeutic device formed on a bracelet.

FIG. 3 shows another exemplary drawing of a therapeutic device formed on a bracelet.

FIG. 4 shows another exemplary drawing of a therapeutic device formed on a bracelet.

FIG. 5 shows another exemplary drawing of a therapeutic device formed on a bracelet.

FIG. 6 shows an exemplary drawing of a therapeutic device in different configurations.

FIG. 7 shows an exemplary drawing of a therapeutic device formed in different configurations.

FIG. 8 shows an exemplary drawing of a therapeutic device formed in different configurations.

FIG. 9 shows an exemplary drawing of a therapeutic device formed with fabric.

FIG. 10 shows an exemplary drawing of a therapeutic device formed with a variety of wearable or support articles.

FIG. 11 shows an exemplary drawing of an external power supply for a therapeutic device.

FIG. 12 shows an exemplary drawing of a therapeutic device having a pair of solar cells.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

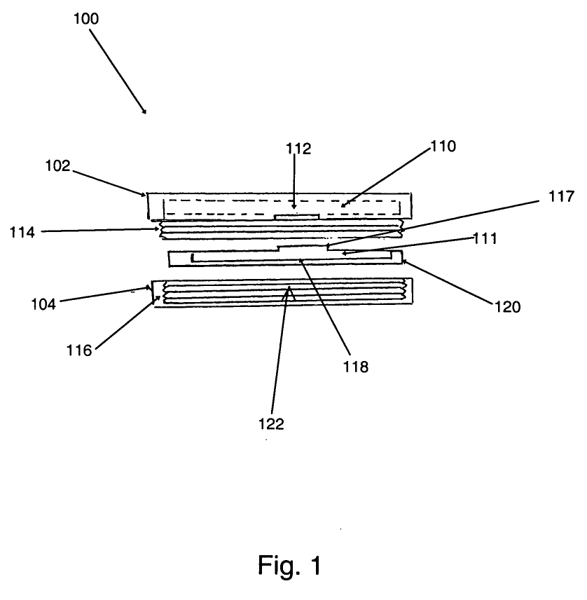

Generally referring to FIGS. 1-11, a therapeutic device is shown. In one exemplary embodiment, an outer skin of the jewelry is used as an electrical conductor. Additionally, another conductor may be disposed between a vibrator motor and a battery. The battery may be, for example, a coin or flat type of battery. Alternatively, any type of battery known to one having ordinary skill in the art may be used. The battery may provide power to a vibrating motor, allowing for the therapeutic device to vibrate or shake or to provide massaging capabilities.

In one exemplary embodiment shown in FIG. 1, a vibrating therapeutic device is shown. In this embodiment, a housing 100 may have a first 102 and second 104 section, a power source 111, a vibrating motor 110, and an actuator 122 for power source 111. Housing sections 102 and 104 may be constructed in any shape or size that may be mounted on a wearable article or worn on a body. Sections 102 and 104 may also be configured to contain vibrating motor 110, power source 111, and an insulator barrier 120, which can separate one pole, for example negative battery post 118 from positive post 117 of power source 111 from vibrating motor 110 or outer housing 104.

Additionally, in this exemplary embodiment, first section 102 may have a male threaded end 114, which can be fitted into female threaded end 116 of second section 104. Alternatively, any other method of securing section 102 to section 104, such as any type of clasp that attaches to sections 102 and 104. In yet another embodiment, a rubber O-ring may be used between section 102 and section 104. The rubber O-ring could act as provide a water-tight seal between section 102 and section 104, preventing potential water damage to any interior components of the vibrating therapeutic device.

In a further embodiment shown in FIG. 1, actuator 122 may be formed in the shape of a spike. Actuator 122 may also activate vibrating motor 110 by penetrating insulator barrier 120, allowing actuator 122 to contact power source 111, thereby allowing current to pass to and activate vibrating motor 110 and causing the therapeutic device to vibrate or shake. Additionally, actuator 122 may penetrate insulator barrier 120 and activate vibrating motor 110 when first section 102 is coupled with second section 104.

In another embodiment, a completed circuit may be broken by loosening the lower portion. When the lower portion of the jewelry is loosened, the connection between the penetrating protrusion and the battery may be broken. The circuit may then be broken, and power may cease to be supplied to the motor. The circuit may again be completed and the motor again powered by tightening the lower portion.

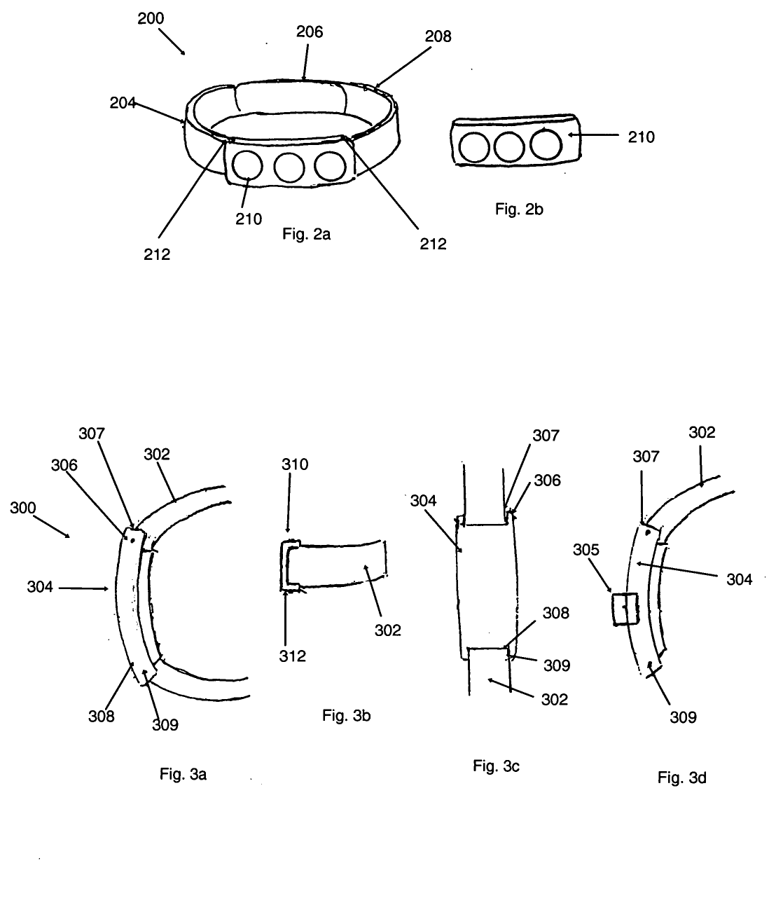

In another embodiment shown in FIG. 2, a therapeutic device may be disposed on a bracelet. Bracelet 200 may be formed in any of a variety of fashions and may be worn on any part of the human body, for example the wrist, ankle or neck. Bracelet 200 may have band 204, which may be formed out of any material, for example metal, rubber, silicone or leather, or any other material known to one of ordinary skill in the art. Additionally, bracelet 200 may have adjustable clasp 206, allowing bracelet 200 to be adjustable in size, so as to allow it to be worn by people of different sizes. Clasp 206 may use a plurality of pin holes 208, which may be disposed on band 204 and allow for adjustment of bracelet 200. Motor and battery housing 210 may also be joined with bracelet 200. In one embodiment, holes 212 may be used to secure motor and battery housing 210 to band 204. Motor and battery housing 210 may also be formed in any shape that can be joined with bracelet 200. Also, in a further embodiment, motor and battery housing 210 may be disposed anywhere on bracelet 200.

In another exemplary embodiment shown in FIG. 2b, motor and battery housing 210 may be substantially rectangular and contain one or more motors and one or more batteries. The number of motors and the number of batteries may be varied depending on the needs or desires of a user. Additionally, housing 210 may be formed in any of a variety of shapes, for example substantially circular, substantially oval, substantially square or any other shape that may be disposed on a bracelet or any other piece of jewelry.

In another embodiment shown in FIG. 3, a housing is shown as attached to a band. In this embodiment, bracelet 300 may include band 302. Band 302 may be made of any material known to one of ordinary skill in the art, such as rubber, silicone, metal or leather. Housing 304 may be made of any material known to one of ordinary skill in the art and may house a motor and a battery. Housing 304 may be connected to band 302 through the use of one or more pins, e.g. 306 and 308. The one or more pins may run through both sides of housing 304 through one or more holes. For example, a first pin 306 may be inserted through a first hole 307 on a first side of housing 304 and run through a hole in band 302 to secure housing 304 to band 302. Housing 304 may further have tabs 310 and 312 disposed at opposite ends of housing 304, as shown in FIG. 3b. Tabs 310 and 312 may extend beyond the edges of housing 304 and may include holes through which a connector pin or pins may be inserted to secure housing 304 to band 302. Additionally, a back view of a therapeutic device is shown in FIG. 3c, whereby it may be shown that housing 304 can couple with a specific portion of band 302. FIG. 3c can also show pin 306 as partially disposed in hole 307, as well pin 308 fully disposed in hole 309.

In another embodiment shown in FIG. 3d, housing 304 may have upper housing 305 mated to lower housing 304. Upper housing 305 may include threading that allows it to be joined to lower housing 304. In one exemplary embodiment, upper housing 305 and lower housing 304 may have mating male and female threaded connectors. Alternatively, upper housing 305 and lower housing 304 may be joined in any manner known to one of ordinary skill in the art. Lower housing 304 may be recessed into band 302 of bracelet 300. Lower housing 304 may be joined with band 302 through the use of connector pins being inserted into holes, as described above, or may be joined in any manner known to one of ordinary skill in the art. Upper housing 305 may be provided for any of a variety of purposes, such as housing a vibrating motor, housing a power source, such as a battery, or for any other purpose. In additional exemplary embodiments, housing 305 may include various ornamental designs or may have the ability to have designs attached through the use of attachment means. These designs may be used to decorate or enhance the appearance of housing 305.

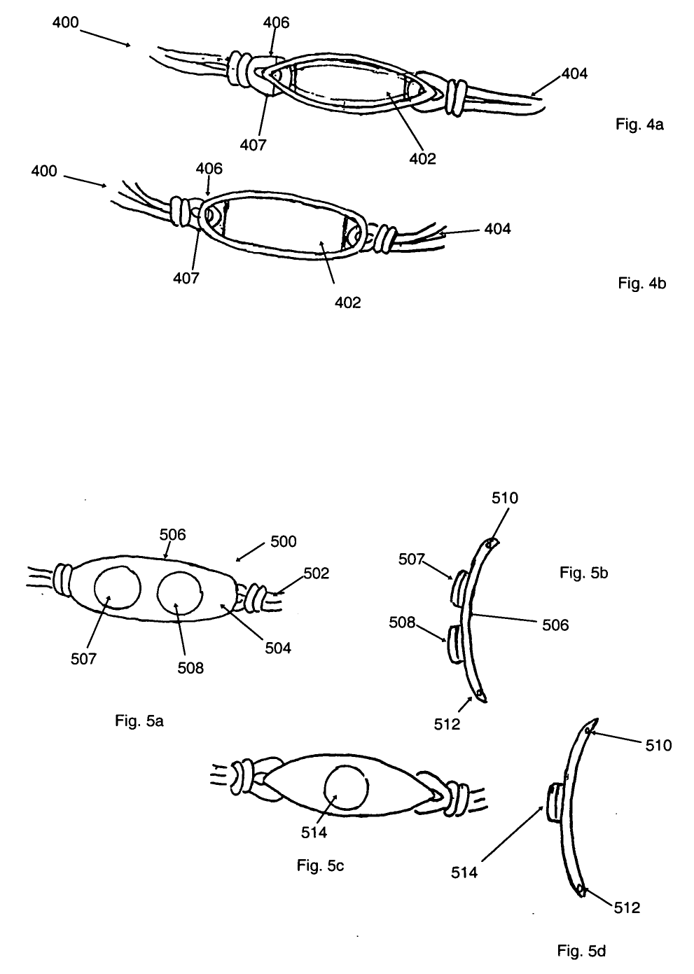

FIG. 4 shows another embodiment of a therapeutic device. FIG. 4a and FIG. 4b show exemplary bottom-up views of a therapeutic device. Here therapeutic device 400 may include bracelet 402 and band 404. In FIG. 4a, band 404 may be mated to bracelet 402 through the use holes 406 and 407 drilled into bracelet 402. This mating may include looping parts of band 404 through holes 406 and 407, which may securely attach the therapeutic device to the bracelet 400. For example, opposite ends of bracelet 402 may then be inserted through the holes in band 404 to secure band 404 to bracelet 402. In FIG. 4b, another exemplary manner of attaching bracelet 402 to band 404 is shown. In this embodiment, holes 406 and 407 may again be drilled into band 404 of bracelet 402.

In additional exemplary embodiments, housing 404 could be incorporated into the embodiments shown in FIGS. 2 and 3. Additionally, a vibrating unit could be placed in band 404, through the use of rubber, Velcro®, leather or the like.

FIG. 5 shows another exemplary embodiment of an adjustable therapeutic device. In a first embodiment shown in FIGS. 5a and 5b, device 500 may have bracelet 504 and band 502 joined together. Additionally, bracelet 504, which may house a motor for a vibrator and a source of power, may be mounted on bracelet 504. Housing 506 may be mounted on band 502 through the use of holes 510 and 512, which may be looped to secure bracelet 504 to band 502. After band 502 is looped through, bracelet 504 may be securely fastened to band 502. Bracelet 504 may include first and second battery and motor housings 507 and 508, or may have a singular battery and motor housing 514, as shown in FIGS. 5c and 5d. Alternatively, bracelet 504 may have any number of battery and motor housings disposed thereon.

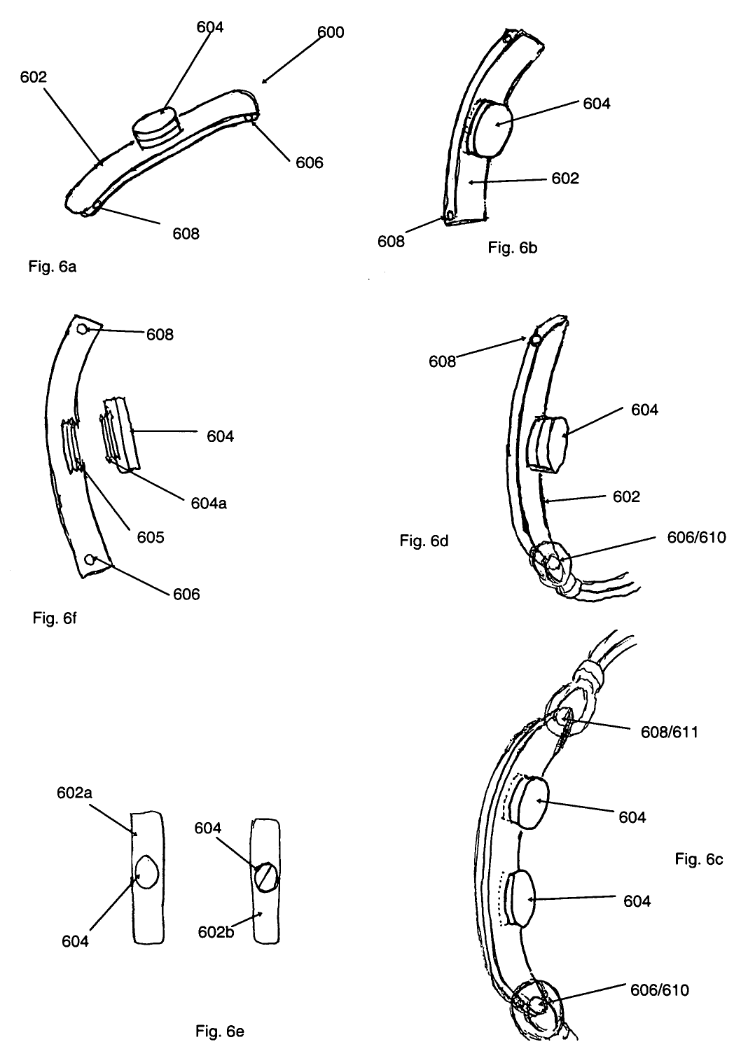

FIG. 6 shows additional exemplary embodiments of an adjustable therapeutic device. In these embodiments a vibrating unit is shown as being disposed on a bracelet in various manners and configurations. In one exemplary embodiment shown in FIG. 6a, bracelet 602 has housing 604 attached. Housing 604 may be either permanently or removably attached to bracelet 602. Also, housing 604 may be attached so that housing 604 affixes to the surface of bracelet 602. Additionally, bracelet 602 may have receiving holes 606 and 608 that allow for bracelet 602 to be connected to an additional length of jewelry. In another exemplary embodiment, housing 604 may be attached to bracelet 602 in such a manner that housing 604 is recessed into bracelet 602, as shown in FIG. 6b. Housing 604 and bracelet 602 may have threading that allows for housing 604 to be screwed into bracelet 602. In yet another exemplary embodiment shown in FIG. 6c, multiple housings 604 may be attached to bracelet 602. Multiple housings 604 may have threading that allows them to be screwed into bracelet 602. Additionally, in this exemplary embodiment, receiving holes 606 and 608 are shown as mated with additionally jewelry lengths 610 and 611, respectively. In yet another exemplary embodiment shown in FIG. 6d, a back view of bracelet 602 is shown. In this embodiment, a single housing 604 is shown as exposed on the underside of bracelet 602.

In yet another exemplary embodiment shown in FIG. 6e, a top-down and bottom-up view of therapeutic device 600 are shown. The bottom portion of bracelet 602 can be shown with element 602a and the top portion of bracelet 602 may be seen with element 602b. Additionally, in another exemplary embodiment shown in FIG. 6f, after a predetermined number of turns, threading 605 disposed on bracelet 602 can thread with threading 604 disposed on housing 604 and engage a battery inside housing 604. The battery inside housing 604 can then power a motor mounted inside housing 604. Further, in this exemplary view, housing 604 can be recessed completely into bracelet 602. Alternatively, when therapeutic device 600 is not activated, housing 604 may extend slightly beyond the exterior of bracelet 602. In a further exemplary embodiment, multiple vibrating units may be used with bracelet 602.

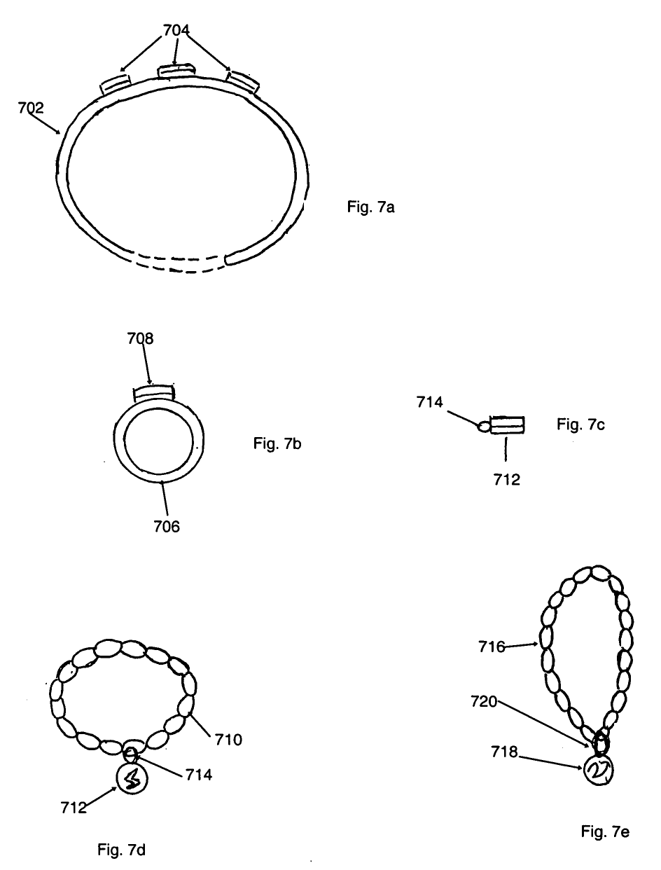

FIG. 7 shows additional exemplary embodiments of a therapeutic device. In one embodiment, housing 704 for one or more batteries and a vibrating motor may be separated or removed from bracelet 702. Bracelet 702 may have an open portion or may be a continuous bangle. If bracelet 702 is formed with an open portion, a clasp may be used to open and close the bracelet. When housing 704 is separated from bracelet 702, any batteries may be replaced and the vibrating motor may be adjusted, repaired or replaced. Additionally, bracelet 702 may be in the form of an open hoop, such as a bracelet shown in FIG. 7a, or a hoop having a clasp that joins one end of bracelet 702 to the other end of bracelet 702.

In other exemplary embodiments, therapeutic device 700 may be formed in the shape of a ring 706, as shown in FIG. 7b and the side view of housing 712 in FIG. 7c. Ring 706 may have housing 708 disposed on the outside of ring 706. Ring 706 may be worn on any appropriate size appendage. Alternatively, therapeutic device 700 may be formed as a bracelet with a housing for one or more batteries and a vibrating motor connected to the bracelet like a pendant, as shown in FIGS. 7d and 7e. For example, bracelet 710 in FIG. 7d may have housing 712 connected with connecting ring 714. Bracelet 710 may also be connected to housing 712 by more than one connecting ring or with various sized connecting rings so that the distance between bracelet 710 and housing 712 may be varied. In another alternative embodiment, therapeutic device 700 may be formed as a necklace, as shown in FIG. 7e. In this embodiment, necklace 716 may be connected to housing 718 by connecting ring 720, similar to the above description regarding bracelet 710.

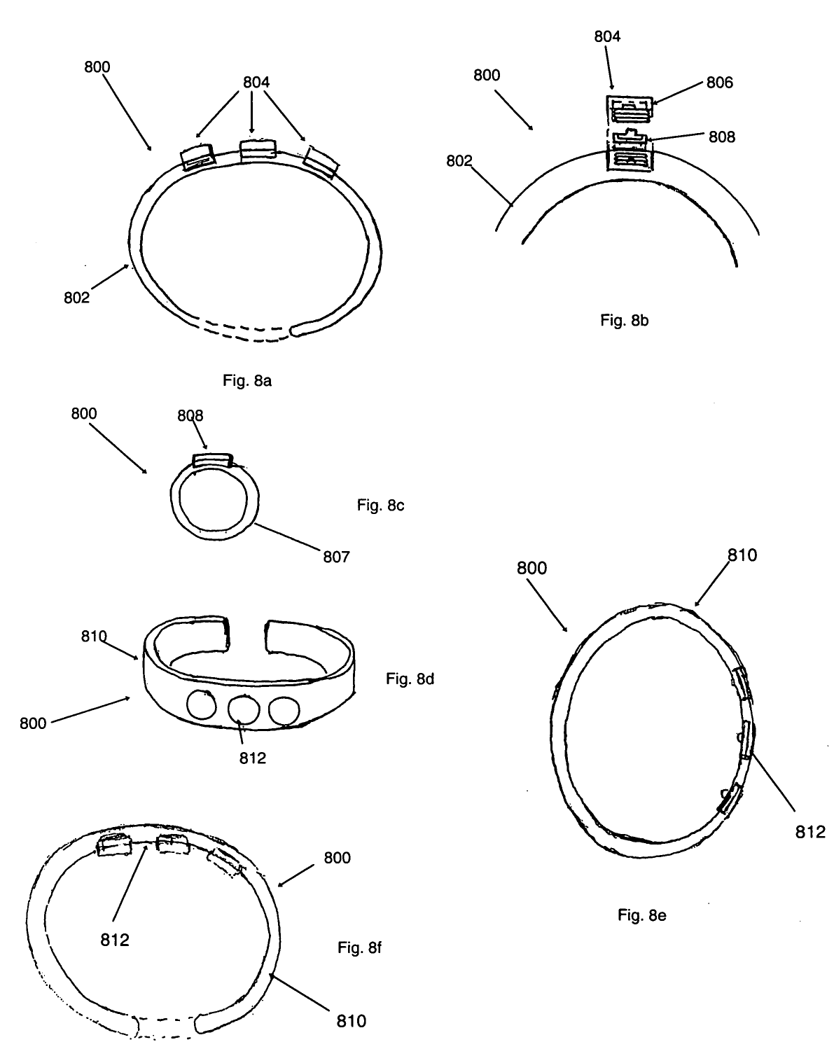

In additional exemplary embodiments shown in FIG. 8, therapeutic device 800 may have any of a variety of configurations. In one embodiment shown in FIG. 8a, bracelet 802 may have one or more housings 804 partially recessed into the surface of bracelet 802. Bracelet 802 may have threaded holes into which one or more housings 804, which can also be threaded, may be screwably inserted. A close-up view of therapeutic device 800 in FIG. 8b shows housing 804 may have a threaded top portion 806 and a threaded bottom portion 808. When top portion 806 engages bottom portion 808, a battery may provide power to a vibrating motor, and activating therapeutic device 800. Additionally, as shown in FIG. 8c, therapeutic device 800 may be formed in the shape of ring, having ring portion 807 and housing 808. Ring portion 807 may have a threaded bottom portion that allows for the insertion of top housing 808, which may also be threaded. Additionally, ring 807 may be adjusted to accommodate different sizes. In yet another embodiment, shown in FIGS. 8d and 8e, therapeutic device 800 may be formed as an open bracelet 810 and have one or more housings 812 disposed on an exterior portion of bracelet 810. Housings 812 may be disposed on bracelet 810 through any of the previously discussed manners or by any other manner known to one having ordinary skill in the art. Additionally, one or more housings 812 may be partially or completely recessed, as seen in the perspective view of FIG. 8e, into bracelet 810, or may be disposed on the surface of the underside of bracelet 810, as shown in FIG. 8f.

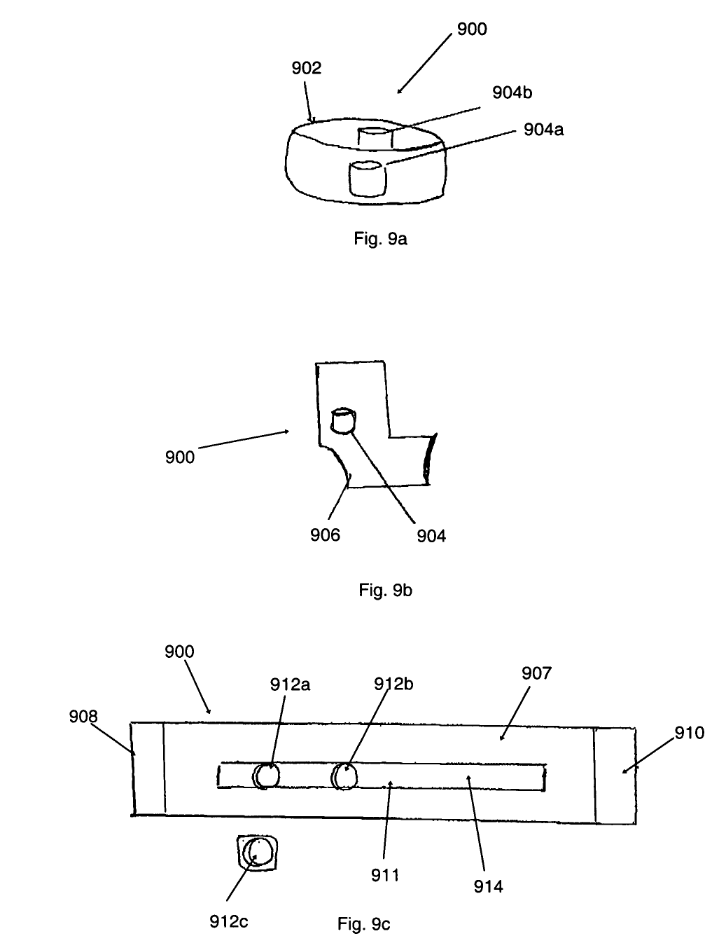

Additional exemplary embodiments of therapeutic devices used in conjunction with a variety of therapeutic braces are shown in FIG. 9. In a first embodiment shown in FIG. 9a, therapeutic device 900 may have an elastic or adjustable band, similar to a padded head band or wrist band, and may include a vibrating motor and battery, such as that described with respect to FIG. 1, in a housing 904. Housing 904 may be, for example, a pocket. Housing 904 may be made of any material or substance known to one of ordinary skill in the art. Additionally, housing 904 may have a Velcro® strip disposed on an exterior portion, allowing housing 904 to be placed in any desired location on therapeutic device 900, such as the location of housing 904a on the exterior of band 902, or housing 904b, on the interior of band 902. Additional housings may be added and used in any location on band 902 that are desired by a user of therapeutic device 902. Elastic band 902 may also have a Velcro® strip disposed on any interior or exterior portion of itself or may have the entirety of the interior or exterior covered in Velcro®, allowing for housing 904 to be attached to elastic band 902. Alternatively, elastic band 902 could include a pocket located on any interior or exterior portion. The pocket could act to securely hold housing 904. Housing 904 and the pocket could both further include Velcro™ to further secure housing 904 within the pocket. Further, elastic band 902 may be formed in any shape or size, or may be adjustable, so as to accommodate a variety of sizes.

In a further exemplary embodiment shown in FIG. 9b, therapeutic device 900 could be formed in the shape of an elastic brace 906, such as an ankle brace, foot brace, wrist brace or hand brace made out of any material, for example neoprene. Brace 906 can also include pocket 904, similar to that described with respect to FIG. 9a, which may be used to store a vibrating motor and battery housing, such as that described with respect to FIG. 1. Pocket 904 may be disposed in any of a variety of locations on either the interior or exterior of brace 906. Pocket 904 may also be movable to any interior and exterior locations on brace 906. Additionally, pocket 904 may be utilized in other environments, such as on an interior or exterior portion of elastic band 902. Also, as shown in FIG. 9c, a therapeutic device 900 could be formed as a wrist brace 907 or any type of brace that wraps around any limb or extremity. Brace 907 may have male and female Velcro® portions 908 and 910, allowing for brace 907 to be secured to a wrist or any other extremity. Alternatively, brace 907 may utilize any other method or device known to one having ordinary skill in the art to secure brace 907 to a wrist or other extremity. One of more vibrating units, such as vibrating units 912a, 912b and 912c may be disposed on brace 907 in any of a variety of manners known to one of ordinary skill in the art. In the exemplary embodiment shown in FIG. 9c, vibrating units 912a and 912b are shown as adhered to strip 911 of brace 907. Vibrating unit 912c is shown as separated from brace 907 but could be attached at point 914, or any other location on strip 911. For example, vibrating units 912 may be fastened to a strip 911 that may be made of fabric or may be adapted to removably receive a vibrating unit in any manner known to one having ordinary skill in the art. In one exemplary embodiment, a plurality of vibrating units 912 may be glued to male Velcro® portion of strip 911. In this embodiment, vibrating units 912 would therefore be able to be positioned in any of a variety of positions depending on how tightly or loosely brace 907 is secured to a wrist or other extremity. In another exemplary embodiment, vibrating units 912 may be removably adhered to any part of portion of brace 907. In this embodiment, a user may position one or more vibrating units 912 in any location of the interior or exterior of brace 907 that they desire or position one or more vibrating units 912 in a location that may provide a desired amount of therapy.

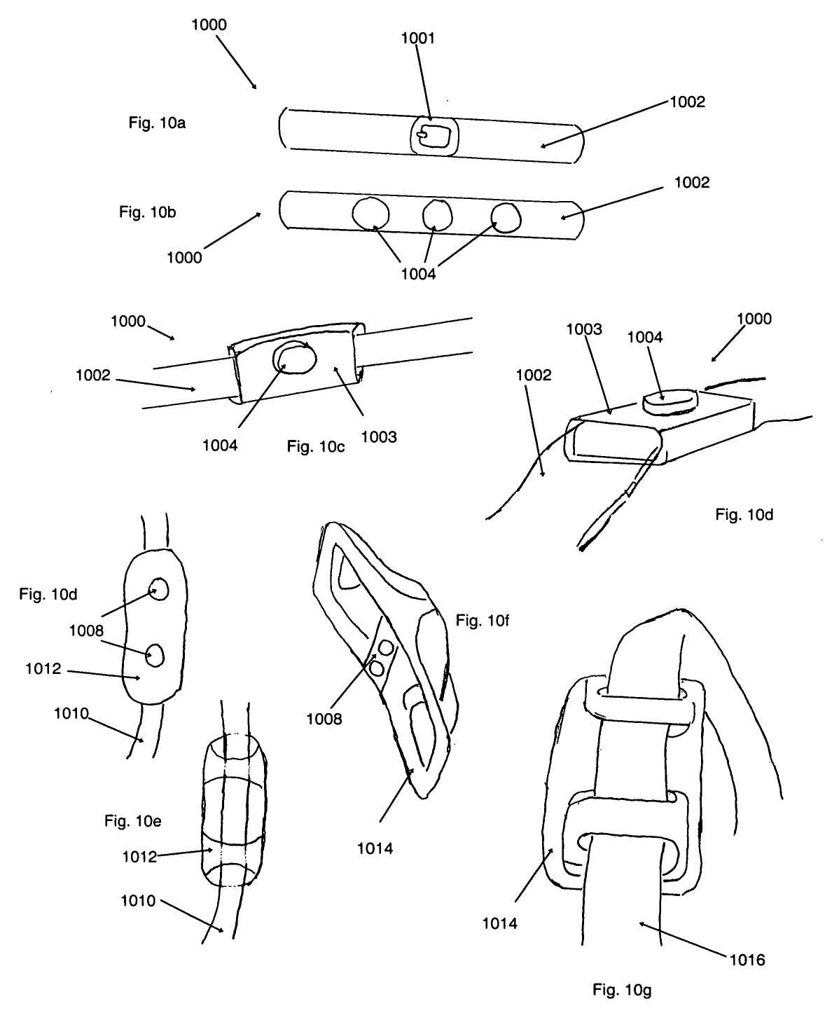

FIG. 10 shows further exemplary embodiments of a therapeutic unit. In one exemplary embodiment shown in FIG. 10a, therapeutic unit 1000 may be disposed on belt 1002 through the use of buckle 1001. The interior portion of belt 1002 may include one or more areas that accept one or more housings 1004, as shown in exemplary FIG. 10b, that house a vibrating motor and battery. One or more housings 1004 may be formed similar to that shown in FIG. 1 and may have a leather cover or a cover of any other material, which may match the material that belt 1002 is made out of. Housings 1004 may be joined with belt 1002 through any of the methods discussed previously or by any method known to one having ordinary skill in the art. Additionally, housings 1004 may be disposed at any location on the belt. Similarly, in FIGS. 10c and 10d, belt 1002 may utilize a different type of slider 1003 on which to mount housing 1004. Thus one or more vibrating units may be fastened to a belt or similar wearable article and slidably positioned in any location or locations desired by a user.

In yet another embodiment shown in FIGS. 10d and 10e, therapeutic device 1000 having one or more housings 1008 that may hold a vibrating motor and battery may be disposed on pad 1012, which may in turn be disposed on a strap 1010. Strap 1010 may be any type of strap used to assist in the carrying of parcels, bags or objects, such as a strap for a musical instrument, a strap for luggage, a strap for a briefcase or a strap for a backpack, for example. Pad 1012 may have openings which allow it to be securely or slidably attached or fastened to strap 1010. Additionally, any number of housings 1008 containing any number of vibrating motors and batteries may be disposed on pad 1012 that is fitted to a strap. Additionally, as shown in FIGS. 10f and 10g, housings 1008 for a therapeutic device may be disposed on a different type of shoulder strap 1014, which may be slidably adhered to any type of strap 1016, allowing it to be positioned in any location desired by a user.

In yet another exemplary embodiment, therapeutic unit 1000 may also be utilized with or incorporated into any of a variety of other products that are commonly used with the human body, for example a seat belt. In one embodiment, therapeutic unit 1000 may be formed with a slidable housing that could fit over a seatbelt and be positioned in any desired location. Additionally in FIGS. 10d-g, a shoulder strap may be formed from heavy plastic, rubber or any other appropriate material known to one having ordinary skill in the art. Additionally, therapeutic until 1000 could then be positioned in any desired location by a user. Similar to other previously described embodiments, therapeutic unit 1000 may be powered by an internal battery or external power source, such as a battery pack or an AC adapter that may be plugged into a car.

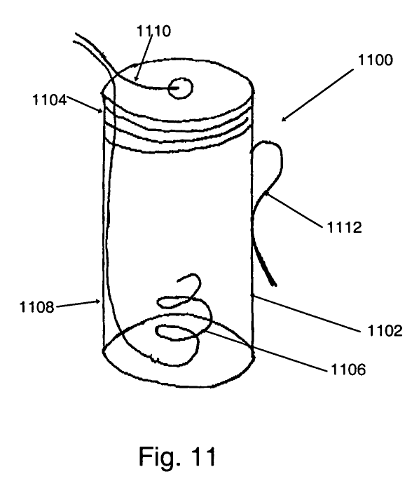

FIG. 11 shows an embodiment of a therapeutic device that uses an external power supply. External power supply 1100 may be used with any therapeutic device described herein either as a backup to the battery mounted in a therapeutic device, such as battery 111. External power supply 1100 may also be used as a primary power source for a therapeutic device. In one embodiment, external power supply 1100 may include a cylinder-shaped housing 1102. Housing 1102 may have a threaded top portion which can receive threaded cap 1104. Additionally, housing 1102 may include spring 1106, which can contact the negative portion of a battery. Negative wire 1108 may be attached to a distal end of spring 1106 and exit housing 1102 through cap 1104. Positive wire 1110 may run through cap 1104 and contact the positive portion of a battery inside housing 1102. Negative wire 1108 and positive wire 1110 may be insulated and connected to a remotely located therapeutic device to provide either auxiliary power or primary power to a vibrating motor in the therapeutic device. External power supply 1100 may be configured to accept any type of battery, for example an MA battery, an M battery, a C battery, a D battery, or any other type of battery known to a person of ordinary skill in the art. External power supply 1100 may also be configured to be worn on the body or clothing of a person. In a further embodiment, external power supply 1100 may include clip 1112, which may be used to clip external power supply 1100 to a belt, pocket, or any other article of clothing on a person utilizing a wearable therapeutic device.

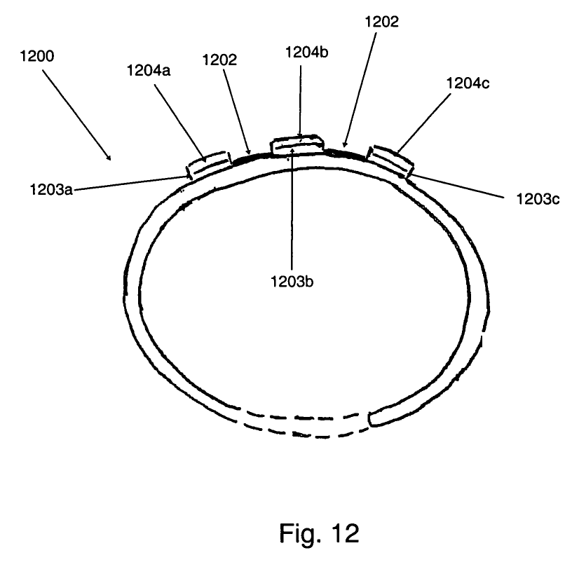

In another exemplary embodiment, a therapeutic vibrating device may be solar powered through the use of one or more solar panels mounted on or nearby the therapeutic vibrating device. The one or more solar panels may be used in conjunction with portable or mobile solar power system known to one having ordinary skill in the art. The one or more solar panels may be mounted on a therapeutic vibrating device and provide power directly to the therapeutic vibrating device or may be mounted remotely and send power to the therapeutic vibrating device. In one exemplary embodiment, shown in FIG. 12, a pair of solar cells may be used to charge a power source on therapeutic device 1200. In this embodiment, solar cells 1202a and 1202b may be disposed on therapeutic device 1200. The one or more solar cells may be attached or connected to therapeutic device 1200 in any manner known to one having ordinary skill in the art. When the one or more solar cells 1202 are exposed to light, they may generate an electrical voltage used to charge a power source. The voltage, in one exemplary embodiment, may be applied to a condenser or one or more rechargeable batteries 1204a, 1204b and 1204c, found in housings 1203a, 1203b, 1203c. One or more rechargeable batteries 1204 may be any size, for example very small so as not to add any significant weight to therapeutic device. In other exemplary embodiments, any of the batteries described above with respect to any of the previous embodiments may be rechargeable batteries. In yet other exemplary embodiments, the rechargeable batteries may be used separately or in conjunction with non-rechargeable batteries. Additionally, rechargeable batteries 1204 may be housed in any type of housing on therapeutic device 1200, such as those pictured in FIG. 12 or any of the housings described above with respect to previous embodiments.

In a further embodiment shown in FIG. 12, the one or more solar cells 1202 may provide therapeutic device 1200 with an indefinite operating life. The greater the amount of exposure to sunlight that one or more solar cells 1202 are able to receive, the more power they may be able to provide over a longer term to the one or more rechargeable batteries. Additionally, the amount of power generated by the one or more solar cells may be varied by changing the size, shape or orientation of the solar panels disposed on therapeutic device 1200. For example, a larger solar cell or cells may be substituted for a smaller solar cell or cells in order to generate more power. In another exemplary embodiment, therapeutic device 1200 may include means for substituting solar cells. In still other exemplary embodiments, one or more solar cells may be disposed on different parts of therapeutic device 1200 so as to provide a better location for solar exposure or to provide a greater solar collection area.

In yet another exemplary embodiment, a therapeutic device may be solar powered and may charge a rechargeable fuel cell while the therapeutic device is not active. Here, a therapeutic device, such as that shown in FIG. 12, may include a switch (not shown) that allows a user to activate or deactivate the one or more vibrating units. Further, in this embodiment, a user may wear the therapeutic device with the vibrating units active, or they may switch the vibrating units off. Alternatively, the user may deactivate the vibrating units and remove the device. However, once the vibrating units are switched off, the device may continue to collect solar energy. The collected solar energy may be converted and used to charge one or more rechargeable batteries connected to the therapeutic device. The rechargeable batteries may store power generated by the solar cells for use at a later time, for example when there is no light available to the one or more solar cells, thus preventing the generation of new power.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed:

1. A therapeutic device, comprising:
at least one power source;
at least one vibrating motor; and
a housing having at least a first portion and a second portion, the housing configured to be mounted to a wearable article and to contain the at least one power source and the at least one vibrating motor in the first portion and second portion, and the first portion and second portion having threading used couple the first portion and the second portion.

2. The therapeutic device of claim 1, further comprising a protrusion in the second portion of the housing which contacts the at least one power source and the at least one vibrating motor when the first portion of the housing is coupled with the second portion of the housing.

3. The therapeutic device of claim 1, wherein the at least one power source is a battery.

4. The therapeutic device of claim 1, wherein the at least one power source is a solar cell.

5. The therapeutic device of claim 1, further comprising an external power source which is remotely located from the therapeutic device and provides power to the therapeutic device.

6. The therapeutic device of claim 5, wherein the external power source is configured to be a wearable article.

7. The therapeutic device of claim 6, wherein the external power source is a solar cell.

8. The therapeutic device of claim 1, wherein the housing is mounted on a bracelet.

9. The therapeutic device of claim 1, wherein the housing is mounted on a ring.

10. The therapeutic device of claim 1, wherein the housing is mounted on a brace for a human joint.

11. The therapeutic device of claim 1, wherein the housing is mounted on a carrying strap.

12. The therapeutic device of claim 1, wherein the housing includes at least two power sources and at least two vibrating motors.

13. A method of providing therapy, comprising:
disposing a vibrating motor in a first portion of a housing;
disposing a power source in a second portion of a housing;
coupling the first portion of the housing with the second portion of the housing;
mounting the housing on a wearable article;
wearing the wearable article;
powering the vibrating motor with the battery; and
vibrating the wearable article through the use of the vibrating motor.

14. The method of providing therapy of claim 13, further comprising:
generating power through the use of a solar cell.

15. The method of providing therapy of claim 13, further comprising:
disposing a wearable external power source remotely from the wearable article.

16. The method of providing therapy of claim 15, wherein external power source is a wearable article.

17. The method of providing therapy of claim 16, wherein the vibrating motor is provided power from the power source when the first portion of the housing is coupled with the second portion of the housing.

18. The method of providing therapy of claim 13, wherein the power source is a battery.

19. The method of providing therapy of claim 13, wherein the wearable article is a piece of jewelry.

20. The method of providing therapy of claim 19, wherein the piece of jewelry is a bracelet.

21. The method of providing therapy of claim 19, wherein the piece of jewelry is a ring.

22. A method of providing therapy with a wearable article, comprising:
means for providing vibrations;
means for providing electric power;
means for housing the vibratory means;
means for mounting;
means for wearing the wearable article on a body or clothing; and
means for activating the means for providing vibrations.

23. The method of providing therapy with a wearable article of claim 22, further comprising:
means for providing auxiliary power to the wearable article.

24. The method of providing therapy with a wearable article of claim 22, further comprising:
means for generating solar power.
